(19) United States
(12) Patent Application Publication
(10) Pub. No.: US 2013/0077730 A1
(43) Pub. Date: Mar. 28, 2013

(54) Nuclear Power Plant

(71) Applicants: Kazuaki KITO, Mito (JP); Masayoshi MATSUURA, Hitachi (JP); Koji ANDO, Hitachi (JP)

(72) Inventors: Kazuaki KITO, Mito (JP); Masayoshi MATSUURA, Hitachi (JP); Koji ANDO, Hitachi (JP)

(73) Assignee: Hitachi-GE Nuclear Energy, Ltd., Hitachi-shi (JP)

(21) Appl. No.: 13/552,757

(22) Filed: Jul. 19, 2012

(30) Foreign Application Priority Data
Jul. 20, 2011 (JP) 2011-158693

(51) Int. Cl. G21C 9/004

(52) U.S. Cl. CPC G21C 9/004
USPC 376/283

(57) ABSTRACT

A nuclear power plant has a reactor pressure vessel, a primary containment vessel and a passive pressure suppression pool cooling system. The reactor pressure vessel is installed in the primary containment vessel. A pressure suppression pool filled with cooling water is formed in a lower portion of the primary containment vessel. The passive pressure suppression pool cooling system is provided with a steam condensing pool in which cooling water is filled, disposed outside the primary containment vessel, a steam condenser disposed in the steam condensing pool, a steam supply pipe connecting the reactor pressure vessel to the steam condenser, and a condensed water discharge pipe connected to the steam condenser for discharging condensed water generated in the steam condenser. Another end portion of the condensed water discharge pipe is disposed in the pressure suppression pool.

### CLAIM OF PRIORITY

The present application claims priority from Japanese Patent application serial no. 2011-158693, filed on Jul. 20, 2011, the content of which is hereby incorporated by reference into this application.

### BACKGROUND OF THE INVENTION

1. Technical Field

The present invention relates to a nuclear power plant and, in particular, to a nuclear power plant suitable for a boiling water reactor nuclear power plant provided with a pressure suppression pool cooling system.

2. Background Art

A nuclear power plant, for example, a boiling water reactor nuclear power plant (hereinafter, referred to as a BWR plant) requires that decay heat in a core be removed even after shutdown of the BWR plant. Normally, the decay heat is removed by drawing part of water from a reactor pressure vessel or a pressure suppression pool provided in a lower portion of a primary containment vessel, and then, returning the water to the reactor pressure vessel or the pressure suppression pool after the water was cooled by a heat exchanger for exchanging heat with sea water.

Such the cooling system uses an electric power driven pump to draw the water from the reactor pressure vessel or the pressure suppression pool and to pump up the sea water for cooling, thus requires an electrical power source for operation. When an abnormal event occurs such as that power transmission to the BWR plant from the outside is stopped, an emergency generator provided to the reactor is activated to operate the cooling system.

On the other hand, as a system for removing the decay heat without an electrical power source when power transmission to the BWR plant from the outside is stopped, for example, an isolation condenser is proposed in Japanese Patent Laid-open No. 62 (1987)-182697.

The isolation condenser has a heat exchanger pipe installed in pool water of an isolation condenser cooling pool, and is a reactor cooling system in which steam is drawn from the reactor pressure vessel to be passed through the heat exchanger pipe and thereby is condensed into condensed water, and is then returned the condensed water to the reactor pressure vessel. This system runs by the weight of the condensed water (water head) as driving power, so that it can operate without an electric power source.

Usually, when equipment for removing the decay heat such as the isolation condenser is not provided or when the startup of the decay heat removing equipment fails, steam generated in the reactor pressure vessel by the decay heat is introduced to the pressure suppression pool to release the decay heat generated in the reactor pressure vessel to the outside of the reactor pressure vessel. At this time, cooling water in the reactor pressure vessel is decreased for the amount of the water discharged to the pressure suppression pool, thus the cooling water must be supplied into the reactor pressure vessel.

As a system for supplying the cooling water into the reactor pressure vessel without an electric power source, a core isolation cooling system is available which supplies the cooling water with a pump using steam drawn from the reactor pressure vessel as driving power.

This core isolation cooling system uses the energy of steam generated in the reactor pressure vessel to drive the pump for supplying the cooling water. Although electric power is needed to control the pump, a battery can be used when no power supply is available from the external power source or the emergency generator.

Since the capacity of the battery for controlling the core isolation cooling system is finite, a large-capacity battery needs to be installed for prolonged operation. In order to solve this problem, Japanese Patent Laid-open No. 9 (1997)-113669 and Japanese Patent Laid-open No. 2001-349975 each propose a system combining the core isolation cooling system and a power generating system.

### CITATION LIST

### Patent Literature

[Patent Literature 1] Japanese Patent Laid-open No. 62 (1987)-182697
[Patent Literature 2] Japanese Patent Laid-open No. 9 (1997)-113669
[Patent Literature 3] Japanese Patent Laid-open No. 2001-349975

### SUMMARY OF THE INVENTION

### Technical Problem

The isolation condenser disclosed in Japanese Patent Laid-open No. 62 (1987)-182697 can remove the decay heat generated in the core of the reactor pressure vessel without an electric power source, but duration of the operation is limited by the water quantity in the cooling pool. Since the decay heat is collected to the cooling pool, the cooling water in the cooling pool is gradually heated, and when the temperature of the cooling water in the cooling pool reaches the boiling point, the cooling water in the cooling pool starts evaporating. In other words, when the cooling water in the cooling pool is gone by evaporation, the operation of the isolation condenser is practically ended.

The cooling pool for the isolation condenser needs to be installed above the reactor pressure vessel because of its operating principle. Thus, when a large-capacity cooling pool needs to be installed for prolonged operation, the cost of construction may increase due to maintaining quake resistance.

In order to avoid this, a cooling water supply system for the cooling pool may be provided while the capacity of the cooling pool is kept small. However in this case, a pump having at least a certain level of pump head needs to be installed because the cooling pool is located high.

On the other hand, the core isolation cooling system can supply the cooling water into the reactor pressure vessel without any power sources except for a battery. As disclosed in Japanese Patent Laid-open No. 9 (1997)-113669 and Japanese Patent Laid-open No. 2001-349975, when the core isolation cooling system and a power generating system are combined, the battery for control can be a small-capacity battery just for stabilizing voltage.

The core isolation cooling system, however, has no function of removing the decay heat generated in the core, so that the decay heat is eventually released to the pressure suppression pool in the primary containment vessel. Thus, in order to run the core isolation cooling system for a prolonged period of time, an apparatus for reducing temperature increase in the pressure suppression pool is needed (in specification of this application, reducing temperature increase is referred to as cooling).

An object of the present invention is to provide a nuclear power plant having a passive pressure suppression pool cooling system that can operate passively without electric power supply from outside and an emergency generator and cool a pressure suppression pool.

### Solution to Problem

A feature of the present invention for accomplishing the above object is a nuclear power plant comprising of a primary containment vessel; a reactor pressure vessel installed in the primary containment vessel; a pressure suppression pool in which first cooling water is filled for reducing pressure increase in the primary containment vessel, installed in a lower portion of the primary containment vessel; and a passive pressure suppression pool cooling system,

Wherein the passive pressure suppression pool cooling system has a steam condensing pool in which second cooling water is filled, disposed outside the primary containment vessel; a steam condenser disposed in the steam condensing pool; a steam supply pipe connecting the reactor pressure vessel to the steam condenser; and a condensed water discharge pipe connected to the steam condenser for discharging condensed water generated in the steam condenser, and;

wherein another end portion of the condensed water discharge pipe is disposed in the pressure suppression pool.

Furthermore, to achieve the above object, a nuclear power plant according to the present invention has a primary containment vessel; a reactor pressure vessel installed in the primary containment vessel; and a pressure suppression pool in which first cooling water is filled for reducing pressure increase in the primary containment vessel, installed in a lower portion of the primary containment vessel; and a passive pressure suppression pool cooling system,

Wherein the passive pressure suppression pool cooling system has a turbine; a first steam supply pipe connecting the reactor pressure vessel to the turbine; a fluid discharge pipe connected to the turbine and having a first end portion disposed in the pressure suppression pool; a cooling water supply pipe connected to the reactor pressure vessel and having a second end portion disposed in the pressure suppression pool; a pump coupled with the turbine and installed to the cooling water supply pipe; a steam condensing pool in which second cooling water is filled, disposed outside the primary containment vessel; a steam condenser disposed in the steam condensing pool; a second steam supply pipe connecting the first steam supply pipe to the steam condenser; and a condensed water discharge pipe connected to the steam condenser and having a third end portion disposed in the pressure suppression pool.

Furthermore, to achieve the above object, a nuclear power plant according to the present invention has a primary containment vessel; a reactor pressure vessel installed in the primary containment vessel; and a pressure suppression pool in which first cooling water is filled for reducing pressure increase in the primary containment vessel, installed in a lower portion of the primary containment vessel; and a passive pressure suppression pool cooling system,

Wherein the passive pressure suppression pool cooling system has a turbine; a first steam supply pipe connecting the reactor pressure vessel to the turbine; a steam discharge pipe connected to the turbine and having a first end portion disposed in the pressure suppression pool; a cooling water supply pipe connected to the reactor pressure vessel and having a second end portion disposed in the pressure suppression pool; a pump coupled with the turbine and installed to the cooling water supply pipe; a steam condensing pool in which second cooling water is filled, disposed outside the primary containment vessel; a steam condenser disposed in the steam condensing pool; a second steam supply pipe connecting the first steam supply pipe to the steam condenser; and a condensed water discharge pipe connecting the steam condenser to the steam discharge pipe.

Furthermore, to achieve the above object, a nuclear power plant according to the present invention has a primary containment vessel; a reactor pressure vessel installed in the primary containment vessel; and a pressure suppression pool in which first cooling water is filled for reducing pressure increase in the primary containment vessel, installed in a lower portion of the primary containment vessel; and a passive pressure suppression pool cooling system,

Wherein the passive pressure suppression pool cooling system has a first turbine; a first steam supply pipe connecting the reactor pressure vessel to the first turbine; a steam discharge pipe connected to the first turbine and having a first end portion disposed in the pressure suppression pool; a cooling water supply pipe connected to the reactor pressure vessel and having a second end portion disposed in the pressure suppression pool; a pump coupled with the turbine and installed to the cooling water supply pipe; a steam condensing pool in which second cooling water is filled, disposed outside the primary containment vessel; a steam condenser disposed in the steam condensing pool; a second steam supply pipe connecting the first steam supply pipe to the steam condenser; a condensed water discharge pipe connected to the steam condenser and having a third end portion disposed in the pressure suppression pool; and a second turbine coupled with a generator, installed to the second steam supply pipe and disposed outside the primary containment vessel.

### Advantageous Effect of the Invention

According to the present invention, cooling water in the pressure suppression pool provided in the primary containment vessel can be cooled by a passive pressure suppression pool cooling system which operates passively without electric power supply from the outside and an emergency generator.

### BRIEF DESCRIPTION OF THE DRAWINGS

FIG. 1 is a structural diagram showing a conventional nuclear power plant having an isolation condenser.

FIG. 2 is a structural diagram showing a nuclear power plant having a passive pressure suppression pool cooling system, according to embodiment 1 which is a preferred embodiment of the present invention.

FIG. 3 is a structural diagram showing another example 1 of a passive pressure suppression pool cooling system which is used in a nuclear power plant according to an embodiment 1.

FIG. 4 is a structural diagram showing another example 2 of a passive pressure suppression pool cooling system which is used in a nuclear power plant according to an embodiment 1.

FIG. 5 is a structural diagram showing a conventional nuclear power plant having a core isolation cooling system.

FIG. 6 is a structural diagram showing a nuclear power plant having a passive pressure suppression pool cooling system, according to embodiment 2 which is another embodiment of the present invention.

FIG. 7 is a structural diagram showing another example 1 of a passive pressure suppression pool cooling system which is used in a nuclear power plant according to an embodiment 2.

FIG. 8 is a structural diagram showing a nuclear power plant having a passive pressure suppression pool cooling system, according to embodiment 3 which is another embodiment of the present invention.

FIG. 9 is a structural diagram showing a nuclear power plant having a passive pressure suppression pool cooling system, according to embodiment 4 which is another embodiment of the present invention.

FIG. 10 is a structural diagram showing another example 2 of a passive pressure suppression pool cooling system which is used in a nuclear power plant according to an embodiment 2.

### DETAILED DESCRIPTION OF THE PREFERRED EMBODIMENTS

The inventors have studied a way to cool the pressure suppression pool provided in the primary containment vessel by a cooling system which operates passively without electric power supply from the outside or a standby generator, and reached a conclusion that steam could be first drawn from the reactor pressure vessel, then condensed in a steam condenser disposed in cooling water in a cooling pool disposed outside the primary containment vessel, and then, released into a pressure suppression pool in a lower portion of the primary containment vessel.

This allows most of the decay heat generated in the reactor pressure vessel to be released outside the primary containment vessel so that the pressure suppression pool provided in the primary containment vessel can be cooled.

Various embodiments of the present invention reflecting the above study result will be described below.

### Embodiment 1

A nuclear power plant having an isolation condenser, according to embodiment 1 which is a preferred embodiment of the present invention, will be explained. The nuclear power plant of the present embodiment is a boiling water reactor plant (BWR plant) as an example. However, a passive pressure suppression pool cooling system used in the BWR plant of the present embodiment can be applied to a system in general which generates steam in a pressure vessel and releases the heat into pool water.

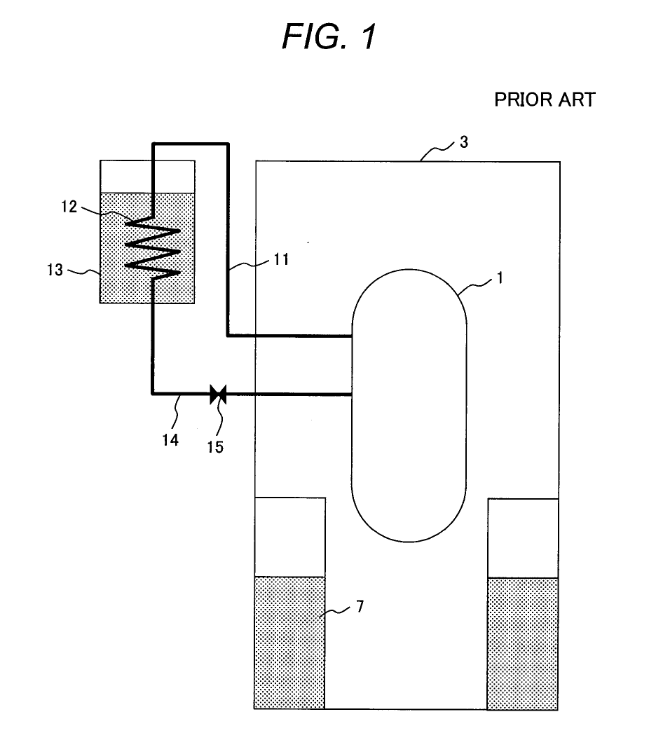

First of all, an example of the structure of a conventional nuclear power plant having an isolation condenser will be described with reference to FIG. 1.

As shown in FIG. 1, a conventional nuclear power plant (a conventional BWR plant) is provided with a primary containment vessel 3, a reactor pressure vessel 1 installed in the primary containment vessel 3, and a pressure suppression pool 7 for reducing pressure increase in the primary containment vessel 3, provided in the lower portion of the primary containment vessel 3.

A steam supply pipe 11 for drawing steam is connected to an upper portion (steam region) of the reactor pressure vessel 1. The steam supply pipe 11 penetrates a sidewall of the primary containment vessel 3 to take itself out of the primary containment vessel 3. The steam supply pipe 11 is connected to an isolation condenser 12 at the outside of the primary containment vessel 3. The isolation condenser 12 is disposed in an isolation condenser cooling pool 13.

Steam condensed in the isolation condenser 12 is passed through a condensed water discharge pipe 14 as the condensed water. The condensed water is eventually returned to the lower portion (water region) of the reactor pressure vessel 1. In addition, the condensed water discharge pipe 14 is provided with an isolation condenser starting valve 15, and the isolation condenser starting valve 15 which is closed during normal operation is opened to start up the isolation condenser.

In an actual BWR plant, isolation valves are provided to the steam supply pipe 11 and the condensed water discharge pipe 14 penetrating the primary containment vessel 3, at the front and the back of the portions penetrating the primary containment vessel 3, but they are not shown in the drawing of the present embodiment. In addition, the reactor isolation cooling system, the isolation condenser, and the passive pressure suppression pool cooling system in the present embodiment have a starting valve which is closed during normal operation but opened for starting up the system, and a check valve and/or a stop valve are provided to each pipe as necessary, but they are not shown in the drawings of the present embodiment.

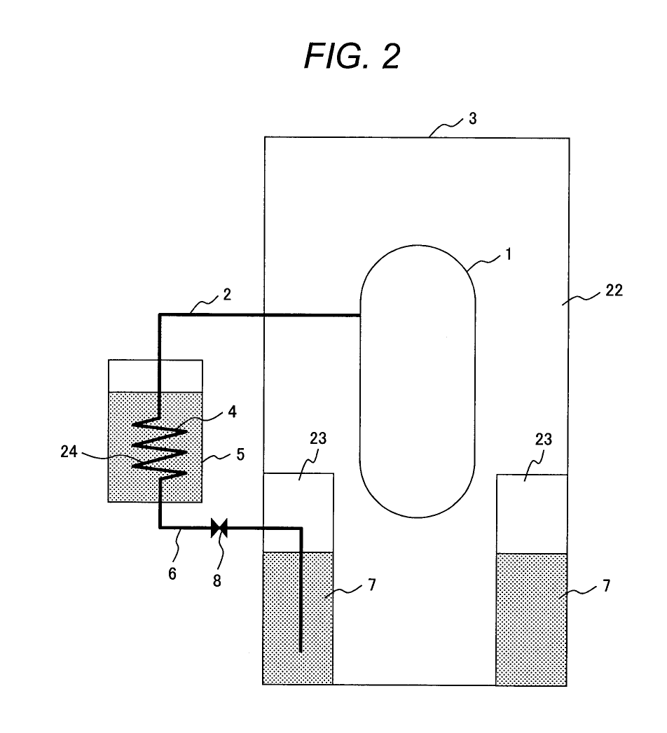

The structure of a passive pressure suppression pool cooling system used in a nuclear power plant according to embodiment 1 of the present invention is shown in FIG. 2.

As shown in FIG. 2, the BWR plant according to the present embodiment also is, in the same manner as that in the conventional BWR plant, provided with a primary containment vessel 3, a reactor pressure vessel 1 installed inside the primary containment vessel 3, and a pressure suppression pool 7 for reducing pressure increase in the primary containment vessel 3, installed in the lower portion of the primary containment vessel 3. A drywell 22 and a pressure suppression chamber 23 separated from the drywell 22 are formed in the primary containment vessel 3. The reactor pressure vessel 1 is disposed in the drywell 22. The pressure suppression pool 7 filled with cooling water is formed in the pressure suppression chamber 23.

In the present embodiment, a steam supply pipe 2 for drawing steam is connected to an upper portion (steam region) of the reactor pressure vessel 1, and the steam supply pipe 2 penetrates a sidewall of the primary containment vessel 3 to take itself out of the primary containment vessel 3. A steam condensing pool 5 disposed at the outside of the primary containment vessel 3. The steam condensing pool 5 is filled with cooling water. A steam condenser 4 having a plurality of heat exchanger tubes 24 disposed in a steam condensing pool 5. The steam supply pipe 2 is connected to a steam condenser 4 and communicated to an inlet of each of the heat exchanger tubes 24. Furthermore, one end portion of a condensed water discharge pipe 6 is connected to the downstream side of the steam condenser 4 and communicated to an outlet of each of the heat exchanger tubes 24. Another end portion of the condensed water discharge pipe 6 is disposed in the pressure suppression pool 7, and the condensed water discharge pipe 6 is provided with a starting valve 8.

The above steam condenser 4 is disposed in the steam condensing pool 5. The water level in the steam condensing pool 5 during normal operation is kept higher than the top of the steam condenser 4, and the top portion of the steam condensing pool 5 is opened to the external environment. If a system for supplying water into the steam condensing pool 5 from the outside is provided, it is effective for maintaining heat removal performance even when the water in the steam condensing pool 5 is decreased.

In such a structure according to the present embodiment, steam condensed in the heat exchanger tubes 24 of the steam condenser 4 is eventually released to the pressure suppression pool 7 in the primary containment vessel 3 through the condensed water discharge pipe 6. The condensed water discharge pipe 6 is provided with a starting valve 8. When an abnormal event is occurred in the BWR plant, the BWR plant is shut down and the starting valve 8 which is closed during normal operation is opened to start up the passive pressure suppression pool cooling system. In the abnormal event, since power supply from outside and an emergency generator to the BWR plant is stopped as described later, the starting valve 8 is opened by electric power supplied from a battery (not shown).

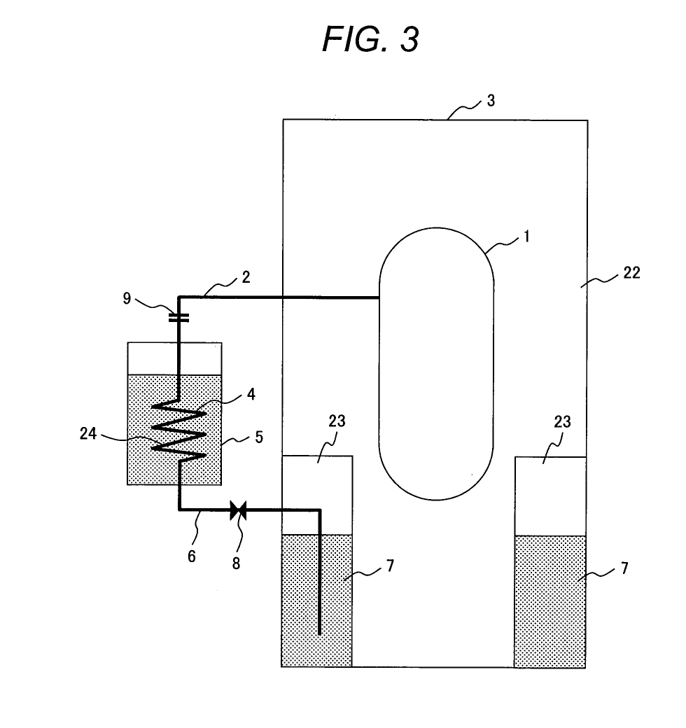

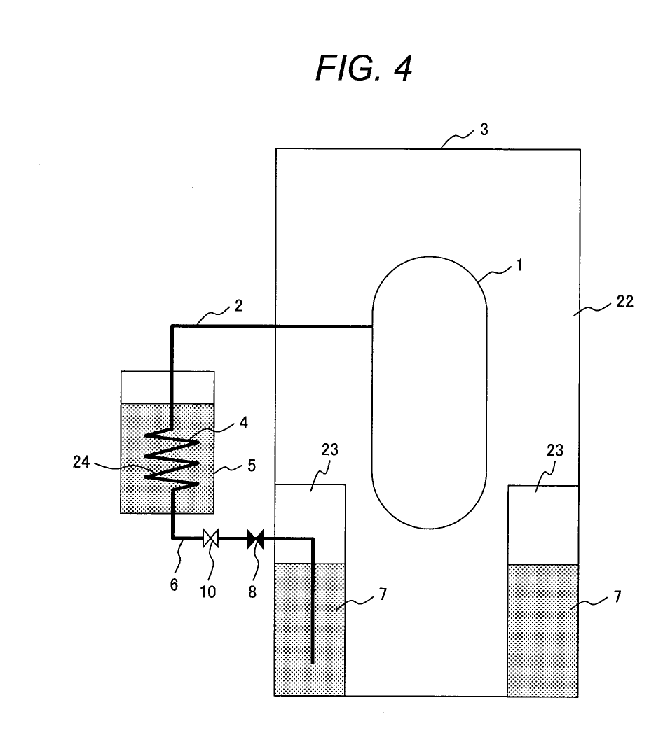

When the flow rate of steam passing the steam condenser 4 is too large, not only the steam may not be condensed sufficiently but also the pressure of the reactor pressure vessel 1 may be drastically decreased. In order to solve these problems, as shown in FIG. 3, an orifice 9 may be installed to the steam supply pipe 2 (another example 1) or, as shown in FIG. 4, a flow control valve 10 may be installed to the condensed water discharge pipe 6 (another example 2).

The orifice 9 in the another example 1 shown in FIG. 3 is better to be installed to the steam supply pipe 2 before a point where steam is condensed, because the orifice 9 can limit the flow rate to the critical flow if it is installed to the place having a high flow rate. However, a certain level of effect can be obtained even when it is installed to the condensed water discharge pipe 6.

Two or more orifices 9 or flow control valves 10 may be provided although a certain effect can be obtained by installing at least one.

On the other hand, when the flow control valve 10 in the another example 2 shown in FIG. 4 is installed to the downstream side of the steam condenser 4, the pressure in the steam condenser 4 is increased and the heat removal performance of the steam condenser 4 is improved. Thus, a greater effect can be obtained by installing the flow control valve to the condensed water discharge pipe 6. However, even when it is installed to the steam supply pipe 2, the effect of limiting the flow rate of steam can still be expected.

In an actual BWR plant, isolation valves are installed to the steam supply pipe 2 and the condensed water discharge pipe 6 penetrating the primary containment vessel 3, at the front and the back of the portions penetrating the primary containment vessel 3, and a check valve and/or a stop valve are installed to each pipe as necessary, but they are not shown in the drawings of the present embodiment.

Next, assuming a rare but severe event such as that the external power source is lost for the BWR plant and the startup of the emergency generator also fails, the operation of the passive pressure suppression pool cooling system in the BWR plant according to the present embodiment started up under the occurrence of such event will be described below.

When the above abnormal event is occurred, first, a control rod (not shown) is inserted into a core (not shown) by scram, then, the reactor power rapidly decreases and the BWR plant is shut down. However, the decay heat is continuously generated in the reactor pressure vessel 1. The decay heat boils the cooling water in the reactor pressure vessel 1 and generates steam. Part or all of the generated steam is drawn through the steam supply pipe 2 when the starting valve 8 is opened by electric power supplied from the battery.

The steam drawn from the reactor pressure vessel 1 is introduced to the steam condenser 4 through the steam supply pipe 2. The steam is condensed in the heat exchanger tubes 24 of the steam condenser 4 by the cooling water in the steam condensing pool 5, and heat held by the steam is released to the cooling water in the steam condensing pool 5. The steam condensed in the steam condenser 4, then, is passed through the condensed water discharge pipe 6 as the condensed water to be released to the pressure suppression pool 7.

When no passive pressure suppression pool cooling system in the BWR plant according to the present embodiment is available, most of the steam generated in the reactor pressure vessel 1 is released to the pressure suppression pool 7 as saturated steam through a safety relief valve (not shown) provided to a main steam pipe (not shown) connected to the reactor pressure vessel.

In contrast to this, in the passive pressure suppression pool cooling system used in the BWR plant according to the present embodiment, the energy of the steam drawn from the reactor pressure vessel 1 is substantially decreased because the steam is condensed into saturated water or subcooled water. Thus, using the present system can greatly reduce the heating (temperature increase) of the cooling water in the pressure suppression pool 7.

In the present embodiment, this effect of reducing the temperature increase of the cooling water in the pressure suppression pool 7 is defined as pressure suppression pool cooling. For example, while saturated water enthalpy under atmospheric pressure is 417 kJ/kg, saturated steam enthalpy is 2657 kJ/kg, which is at least 6 times.

Next, a difference between the isolation condenser in a conventional nuclear power plant and the passive pressure suppression pool cooling system in the BWR plant according to the present embodiment will be described.

As described above, the isolation condenser in the conventional BWR plant shown in FIG. 1 requires that the isolation condenser 12 and the isolation condenser cooling pool 13 be installed higher than the reactor pressure vessel 1. This is because the isolation condenser 12 is a system which uses the weight of the water condensed in the heat exchanger tubes of the isolation condenser 12 as the driving power to return the condensed water to the reactor pressure vessel 1.

On the other hand, the passive pressure suppression pool cooling system in the BWR plant according to the present embodiment uses a pressure difference between the reactor pressure vessel 1 and the pressure suppression pool 7 as the driving power for passing steam, so that more steam can be supplied to the steam condenser 4 as necessary.

The isolation condenser in the conventional BWR plant and the passive pressure suppression pool cooling system in the BWR plant according to the present embodiment both heat/boil he cooling water in the cooling pool (the isolation condenser cooling pool 13 in the conventional example and the steam condensing pool 5 in the present embodiment), and remove the decay heat generated in the reactor pressure vessel 1. For this reason, it takes a large amount of the cooling water in the cooling pool to run these systems for a prolonged period of time.

Since the isolation condenser in the conventional BWR plant requires the isolation condenser cooling pool 13 be installed higher than the reactor pressure vessel 1, providing a large-capacity cooling pool for prolonged operation may increase the cost of construction due to maintaining quake resistance.

In contrast, the steam condensing pool 5 of the passive pressure suppression pool cooling system in the BWR plant according to the present embodiment has less limitation in installing height and can be installed to a wide range, from a location lower than the pressure suppression pool 7 to a location tens of meters higher than the pressure suppression pool 7, although it may depend on the setting of the operation range to be used (pressure difference between the reactor pressure vessel 1 and the pressure suppression pool 7). Installing the cooling pool at a low position has an advantage that water supply to the cooling pool is easy. Thus, temperature increase of the cooling water in the pressure suppression pool 7 caused by removing the decay heat for a prolonged period of time can be easily controlled.

As above, the passive pressure suppression pool cooling system used in the BWR plant according to the present embodiment can operate passively without electric power supply from the outside and the emergency generator to cool the cooling water in the pressure suppression pool installed in the primary containment vessel.

### Embodiment 2

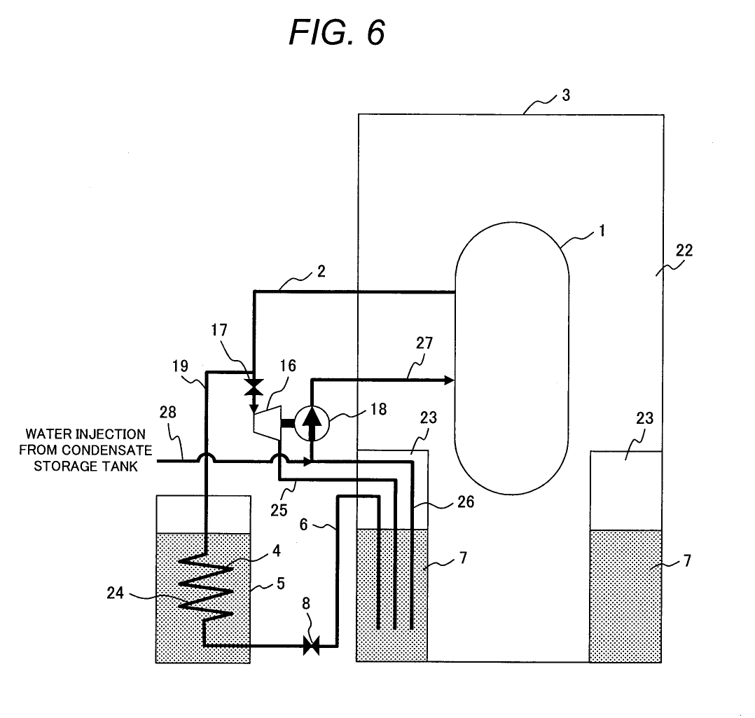

A nuclear power plant having a passive pressure suppression pool cooling system, according to embodiment 2 which is another embodiment of the present invention, will be described by referring to FIG. 6. The nuclear power plant according to the present embodiment is a BWR plant. The BWR plant of the present embodiment has the passive pressure suppression pool cooling system used in the BWR plant according to the embodiment 1 and the core isolation cooling system used in the conventional BWR plant shown in FIG. 1.

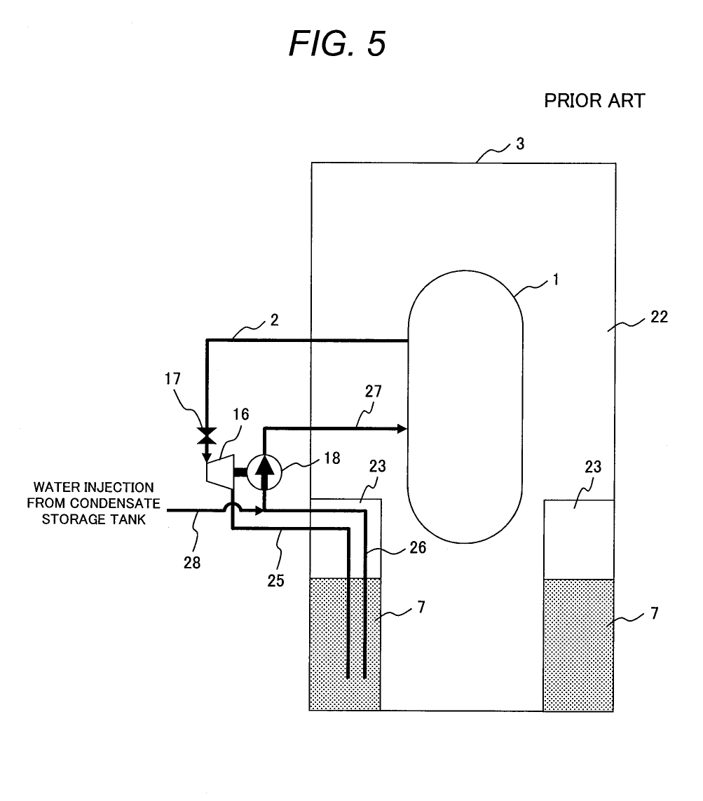

First of all, an example of a structure of a core isolation cooling system in a conventional BWR plant will be described with reference to FIG. 5.

As shown in FIG. 5, a nuclear power plant (a conventional BWR plant) is provided with a primary containment vessel 3, a reactor pressure vessel 1 installed in a drywell 22 of the primary containment vessel 3, and a pressure suppression pool 7 for reducing pressure increase in the primary containment vessel 3, installed in the lower portion of the primary containment vessel 3.

A steam supply pipe 2 for drawing steam is connected to an upper portion (steam region) of the reactor pressure vessel 1, and the steam supply pipe 2 penetrates a sidewall of the primary containment vessel 3 to be connected to a turbine 16 for driving a water injection pump 18. The turbine 16 is coupled with the water injection pump 18. A starting valve 17 is installed to the steam supply pipe 2. The starting valve 17 is closed during normal operation, and opened when the core isolation cooling system is started up. Steam discharged from the turbine 16 is passed through a steam discharge pipe 6, and is eventually released to the pressure suppression pool 7 in the primary containment vessel 3 for condensation.

As a water injection system for the reactor pressure vessel 1, two systems are provided here, for example. One has a condensate storage tank (not shown) outside the primary containment vessel 3 as a water source, wherein cooling water is drawn from the condensate storage tank to be pressurized by the water injection pump 18 coupled with the turbine 16 for operation, and supplied into the reactor pressure vessel 1 through a water supply pipe 27. The other system draws cooling water from the pressure suppression pool 7 in the primary containment vessel 3 through a water supply pipe 26, then pressurizes the cooling water by the water injection pump 18 in the same manner, and supplied into the reactor pressure vessel 1 through the water supply pipe 27. Normally, the cooling water is supplied from the condensate storage tank to the reactor pressure vessel 1, and when the cooling water quantity in the condensate storage tank is decreased, the supply source is switched from the condensate storage tank to the pressure suppression pool 7.

In an actual BWR plant, isolation valves are installed to the steam supply pipe 2 and the water supply pipe 27 penetrating the primary containment vessel 3, at the front and the back of each portion penetrating the primary containment vessel 3, though they are not shown in FIG. 5. A check valve and/or a stop valve are installed to each pipe as necessary, though they are not shown in FIG. 5.

Normally, the cooling water in the reactor pressure vessel 1 is heated by the decay heat generated in the reactor pressure vessel 1, and steam is generated in the reactor pressure vessel 1. Part of the generated steam is used to operate the turbine 16 in the core isolation cooling system. Generally, the quantity of the steam used by the turbine 16 is less than the quantity of the steam generated by the decay heat, thus, most of the steam generated by the decay heat is released to the pressure suppression pool 7 through the safety relief valve (not shown) installed to the main steam pipe (not shown) connected to the reactor pressure vessel 1. When the core isolation cooling system is operated longer than assumed, the temperature of cooling water in the pressure suppression pool 7 is gradually increased, which may increase the pressure inside the primary containment vessel 3.

The nuclear power plant having the passive pressure suppression pool cooling system, according to embodiment 2 is shown in FIG. 6.

As shown in FIG. 6, the structure of the passive pressure suppression pool cooling system used in the BWR plant according to the present embodiment is approximately the same as the conventional BWR plant shown in FIG. 5 except that, in the present embodiment, a steam supply pipe 19, a steam condenser 4, a steam condensing pool 5 and a condensed water discharge pipe 6. The passive pressure suppression pool cooling system used in the BWR plant according to the present embodiment is provided with a turbine 16, a water injection pump 18, a steam condenser 4 and a steam condensing pool 5. A turbine 16, a water injection pump 18, a steam condenser 4 and a steam condensing pool 5 are disposed outside the primary containment vessel 3. The steam supply pipe 2 to which the starting valve 17 is installed is connected the turbine 16 to the reactor pressure vessel 1. One end portion of a steam discharge pipe 25 is connected to the turbine 16, and another end portion of the steam discharge pipe 25 is disposed in the pressure suppression pool 7. A water injection pump 18 is coupled with the turbine 16. One end portion of a water supply pipe 27 is connected to the water injection pump 18, and another end portion of the water supply pipe 26 is disposed in the pressure suppression pool 7. A water supply pipe 27 is connected the water injection pump 18 to the reactor pressure vessel 1. A water supply pipe 28 is connected a condensate storage tank (not shown) to the water supply pipe 26. The steam condenser 4 having heat exchanger tubes 24 is disposed in the steam condensing pool 5 in which cooling water is filled. The steam supply pipe 19 for drawing part of steam from the steam supply pipe 2 is connected the steam condenser 4 to the steam supply pipe 2 at the upstream side of the starting valve 17. The steam supply pipe 2, the condensed water discharge pipe 6, the steam discharge pipe 25, the water supply pipe 26 and the water supply pipe 27 penetrate a sidewall of the primary containment vessel 3.

One end portion of the condensed water discharge pipe 6 to which the starting valve 8 is installed is connected to the steam condenser 4, and another end portion of the condensed water discharge pipe 6 is disposed in the pressure suppression pool 7.

The water condensed through the steam condenser 4 is eventually released to the pressure suppression pool 7 in the primary containment vessel 3 through the condensed water discharge pipe 6. When the starting valve 8 closed during normal operation is opened, the passive pressure suppression pool cooling system is started up.

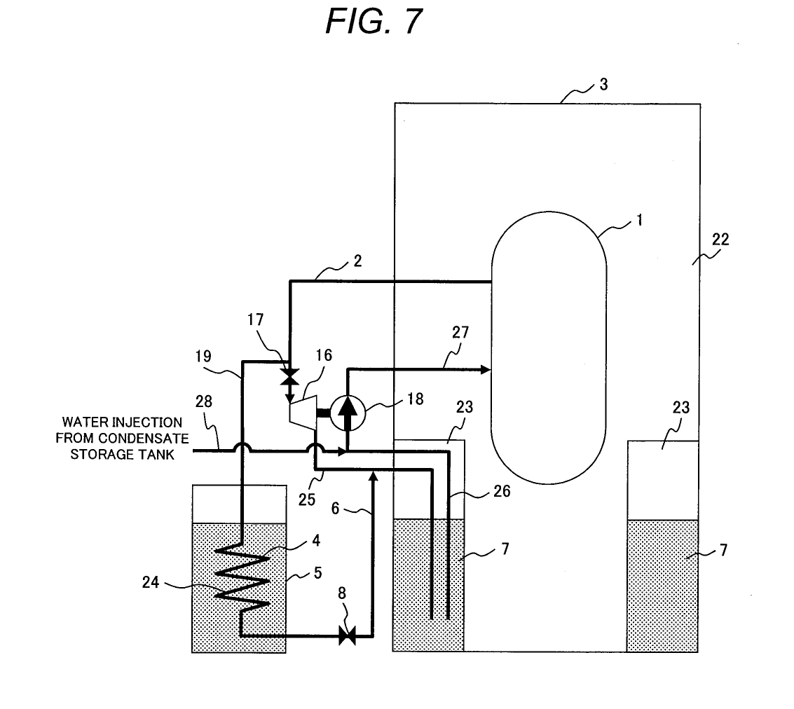

In the present embodiment, each another end portion of the steam discharge pipe 25 and the condensed water discharge pipe 6 is individually disposed in the pressure suppression pool 7, but as shown in another example 1 in FIG. 7, the condensed water discharge pipe 6 may be connected to the steam discharge pipe 25 at outside the primary containment vessel 3.

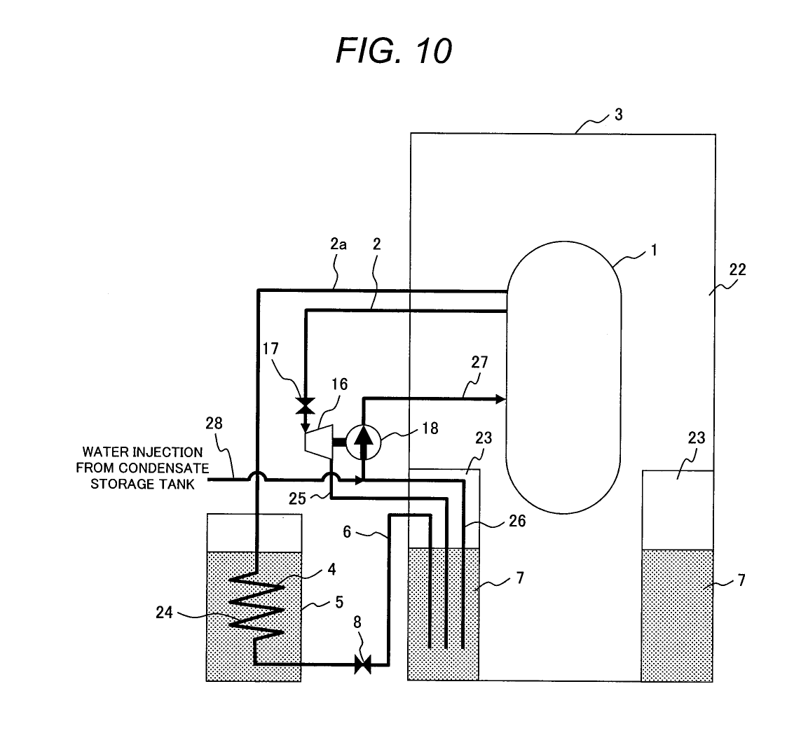

The passive pressure suppression pool cooling system used in the BWR plant according to the present invention shown in the embodiment 1 may be used in the BWR plant shown in FIG. 5. A structure of a BWR plant in this case is shown in another example 2 of the embodiment 2 in FIG. 10. That is, the steam supply pipe 19 is installed to draw part of steam from the steam supply pipe 2 in FIG. 6, whereas in the present embodiment, as shown in FIG. 10, the reactor pressure vessel 1 and the steam condenser 4 are directly connected through a steam supply pipe 2a. The other structure is the same as that in FIG. 6.

The structure in the present embodiment may include the orifice and/or the flow control valve installed to each pipe as shown in FIGS. 3 and 4.

In an actual BWR plant, isolation valves are installed to the steam supply pipe 2, the condensed water discharge pipe 6, the steam discharge pipe 25, the water supply pipe 26 and the water supply pipe 27 penetrating the primary containment vessel 3, at the front and the back of the portions penetrating the primary containment vessel 3, and a check valve and/or a stop valve are installed to each pipe as necessary, but they are not shown in the drawings of the present embodiment.

The structure of the present embodiment such as this can operate passively without electric power supply from the outside and the emergency generator in the same manner as that in the embodiment 1, to cool the cooling water in the pressure suppression pool installed in the primary containment vessel. That is, assuming a rare but severe event such as that the external power source is lost for the BWR plant and the startup of the emergency generator also fails, the BWR plant is shut down and the starting valve 8 is opened by electric power supplied from a battery (not shown). The decay heat generated in the reactor pressure vessel 1 is heated the cooling water in the reactor pressure vessel 1 and thus, the steam generates in the reactor pressure vessel 1. The generated steam is introduced from the reactor pressure vessel 1 to the turbine 16 through the steam supply pipe 2, and rotates the turbine 16. The steam discharged from the turbine 16 is introduced in the pressure suppression pool 7 and condensed by the cooling water in the pressure suppression pool 7. The cooling water in the pressure suppression pool 7 is introduced in the water injection pump 18 through the water supply pipe 26, and pressurized by the water injection pump 18. The cooling water discharged from the water injection pump 18 is supplied into the reactor pressure vessel 1 through the water supply pipe 27. Part of the steam passing through the steam supply pipe 2 is introduced in the steam condenser 4 through the steam supply pipe 19, and condensed by the cooling water in the steam condensing pool 5 in the heat exchanger tubes 24 of the steam condenser 4. The condensed water generated by condensing the steam is discharged from the steam condenser 4, and introduced in the pressure suppression pool 7 through the condensed water discharge pipe 6.

### Embodiment 3

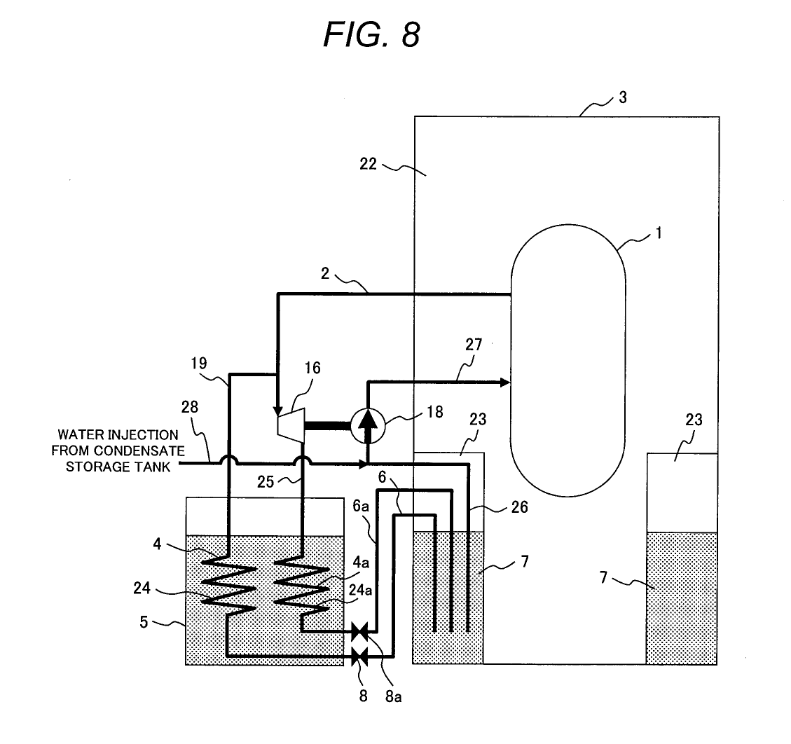

A nuclear power plant having a passive pressure suppression pool cooling system, according to embodiment 3 which is another embodiment of the present invention, will be described by referring to FIG. 8. The nuclear power plant according to the present embodiment is a BWR plant.

A difference between the embodiments 3 and 2 is that the BWR plant of the embodiment 3 has a steam condenser 4a connected to an outlet of the turbine 16. That is, as shown in FIG. 8, the steam discharge pipe 25 connected to the outlet of the turbine 16 is connected to the steam condenser 4a disposed in the steam condensing pool 5. The steam is condensed by the cooling water in the steam condensing pool 5 in the heat exchanger tube 24a of the steam condenser 4a. The condensed water generated by the condensation of the steam is introduced in the pressure suppression pool 7 through a condensed water discharge pipe 6a, and released to the cooling water in the pressure suppression pool 7. A fluid discharge pipe includes the steam discharge pipe 25 and the condensed water discharge pipe 6a, and the steam condenser 4a is installed to the fluid discharge pipe in the steam condensing pool 5.

A starting valve 8a is installed to the condensed water discharge pipe 6a, closed during normal operation, and opened to start up the passive pressure suppression pool cooling system.

The present embodiment can obtain effects generated by the embodiments 1 and 2. Furthermore, according to the present embodiment, the cooling effect of the pressure suppression pool 7 is further improved because the steam discharged from the turbine 16 is condensed in the steam condenser 4a.

In addition, the condensed water discharge pipe 6 may be connected to the condensed water discharge pipe 6a at a downstream side of the starting valve 8a as shown in FIG. 7 or, as shown in FIGS. 3 and 4, the orifice 9 and/or the flow control valve 10 may be installed to the steam supply pipe 19 and/or condensed water discharge pipe 6.

In an actual BWR plant, isolation valves are installed to the steam supply pipe 2, the condensed water discharge pipes 6 and 6a, the water supply pipe 26 and the water supply pipe 27 penetrating the primary containment vessel 3, at the front and the back of the portions penetrating the primary containment vessel 3, and a check valve and/or a stop valve are installed to each pipe as necessary, but they are not shown in FIG. 8.

### Embodiment 4

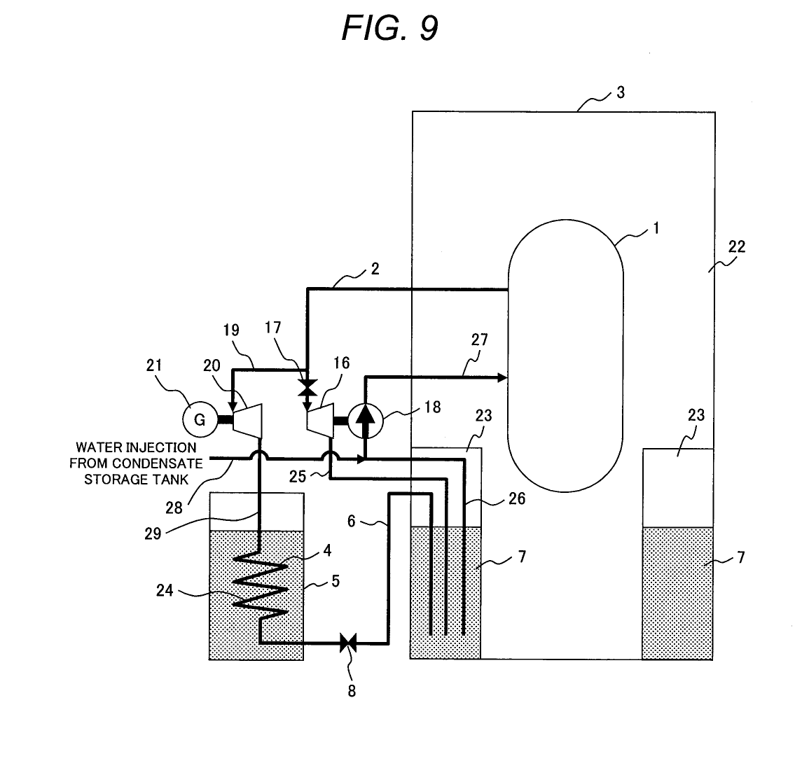

A nuclear power plant having a passive pressure suppression pool cooling system, according to embodiment 4 which is another embodiment of the present invention, will be described by referring to FIG. 9. The nuclear power plant according to the present embodiment is a BWR plant.

A difference between the present embodiment and the embodiment 2 is that the present embodiment has a turbine 20 and a generator 21 such as those proposed in Japanese Patent Laid-open No. 9 (1997)-113669 and Japanese Patent Laid-open No. 2001-349975, installed to the steam supply pipe 19. That is, as shown in FIG. 9, the turbine 20 is installed to the steam supply pipe 19 and the generator 21 is directly coupled with the turbine 20. A steam discharge pipe 29 connected to an outlet of the turbine 20 is connected to the steam condenser 4 disposed in the steam condensing pool 5. The other structure is the same as that in Example 2. Part of the steam passing through the steam supply pipe 2 is supplied to the turbine 20. The turbine 20 is rotated by the steam and the generator 21 coupled with the turbine 20 is also rotated. Thus, electric power is generated. The steam discharged from the turbine 20 is introduced in the steam condenser 4 through steam discharge pipe 29, and condensed in the steam condenser 4. The condensed water is released to the cooling water in the pressure suppression pool 7 through the condensed water discharge pipe 6.

The present embodiment can obtain effects generated by the embodiments 1 and 2. Furthermore, according to the present embodiment, although in the embodiments 1, 2 and 3, the operation of passive pressure suppression pool cooling system requires a battery for control, having the system with generator equipment (the turbine 20 and generator 21) not only allows reducing the capacity of the battery used when the external power source and the emergency generator is not available but also allows supplying power to the other equipment which requires power.

In the present embodiment also, the condensed water discharge pipe 6 may be connected to the steam discharge pipe 25 in the same manner as that in the above example, or the orifice 9 and/or the flow control valve 10 may be installed to each pipe.

In an actual BWR plant, isolation valves are installed to the steam supply pipe 2, the condensed water discharge pipe 6, the steam discharge pipe 25, the water supply pipe 26 and the water supply pipe 27 penetrating the primary containment vessel 3, at the front and the back of the portions penetrating the primary containment vessel 3, and a check valve and/or a stop valve are installed to each pipe as necessary, but they are not shown in FIG. 9.

### REFERENCE SIGNS LIST

1: reactor pressure vessel, 2, 2a, 19: steam supply pipe, 3: primary containment vessel, 4, 4a: steam condenser, 5: steam condensing pool, 6, 6a: condensed water discharge pipe, 7: pressure suppression pool, 8, 8a, 17: starting valve, 9: orifice, 10: flow control valve, 16, 20: turbine, 18: water injection pump, 21: generator, 22: drywell, 23: pressure suppression chamber, 25: steam discharge pipe, 26, 27: water supply pipe.

What is claimed is:

1. A nuclear power plant comprising:
a primary containment vessel; a reactor pressure vessel installed in the primary containment vessel; a pressure suppression pool in which first cooling water is filled for reducing pressure increase in the primary containment vessel, installed in a lower portion of the primary containment vessel; and a passive pressure suppression pool cooling system,
Wherein the passive pressure suppression pool cooling system has a steam condensing pool in which second cooling water is filled, disposed outside the primary containment vessel; a steam condenser disposed in the steam condensing pool; a steam supply pipe connecting the reactor pressure vessel to the steam condenser; and a condensed water discharge pipe connected to the steam condenser for discharging condensed water generated in the steam condenser, and;
wherein another end portion of the condensed water discharge pipe is disposed in the pressure suppression pool.

2. A nuclear power plant comprising:
a primary containment vessel; a reactor pressure vessel installed in the primary containment vessel; and a pressure suppression pool in which first cooling water is filled for reducing pressure increase in the primary containment vessel, installed in a lower portion of the primary containment vessel; and a passive pressure suppression pool cooling system,
Wherein the passive pressure suppression pool cooling system has a turbine; a first steam supply pipe connecting the reactor pressure vessel to the turbine; a fluid discharge pipe connected to the turbine and having a first end portion disposed in the pressure suppression pool; a cooling water supply pipe connected to the reactor pressure vessel and having a second end portion disposed in the pressure suppression pool; a pump coupled with the turbine and installed to the cooling water supply pipe; a steam condensing pool in which second cooling water is filled, disposed outside the primary containment vessel; a steam condenser disposed in the steam condensing pool; a second steam supply pipe connecting the first steam supply pipe to the steam condenser; and a condensed water discharge pipe connected to the steam condenser and having a third end portion disposed in the pressure suppression pool.

3. The nuclear power plant according to claim 2,
wherein other steam condenser is disposed in the steam condensing pool, and the other steam condenser is installed to the fluid discharge pipe in the steam condensing pool.

4. A nuclear power plant comprising:
a primary containment vessel; a reactor pressure vessel installed in the primary containment vessel; and a pressure suppression pool in which first cooling water is filled for reducing pressure increase in the primary containment vessel, installed in a lower portion of the primary containment vessel; and a passive pressure suppression pool cooling system,
Wherein the passive pressure suppression pool cooling system has a turbine; a first steam supply pipe connecting the reactor pressure vessel to the turbine; a steam discharge pipe connected to the turbine and having a first end portion disposed in the pressure suppression pool; a cooling water supply pipe connected to the reactor pressure vessel and having a second end portion disposed in the pressure suppression pool; a pump coupled with the turbine and installed to the cooling water supply pipe; a steam condensing pool in which second cooling water is filled, disposed outside the primary containment vessel; a steam condenser disposed in the steam condensing pool; a second steam supply pipe connecting the first steam supply pipe to the steam condenser; and a condensed water discharge pipe connecting the steam condenser to the steam discharge pipe.

5. A nuclear power plant comprising:
a primary containment vessel; a reactor pressure vessel installed in the primary containment vessel; and a pressure suppression pool in which first cooling water is filled for reducing pressure increase in the primary containment vessel, installed in a lower portion of the primary containment vessel; and a passive pressure suppression pool cooling system,
Wherein the passive pressure suppression pool cooling system has a first turbine; a first steam supply pipe connecting the reactor pressure vessel to the first turbine; a steam discharge pipe connected to the first turbine and having a first end portion disposed in the pressure suppression pool; a cooling water supply pipe connected to the reactor pressure vessel and having a second end portion disposed in the pressure suppression pool; a pump coupled with the turbine and installed to the cooling water supply pipe; a steam condensing pool in which second cooling water is filled, disposed outside the primary containment vessel; a steam condenser disposed in the steam condensing pool; a second steam supply pipe connecting the first steam supply pipe to the steam condenser; a condensed water discharge pipe connected to the steam condenser and having a third end portion disposed in the pressure suppression pool; and a second turbine coupled with a generator, installed to the second steam supply pipe a and disposed outside the primary containment vessel.

6. A nuclear power plant comprising:
a primary containment vessel; a reactor pressure vessel installed in the primary containment vessel; and a pressure suppression pool in which first cooling water is filled for reducing pressure increase in the primary containment vessel, installed in a lower portion of the primary containment vessel; and a passive pressure suppression pool cooling system,
Wherein the passive pressure suppression pool cooling system has a turbine; a first steam supply pipe connecting the reactor pressure vessel to the turbine; a seam discharge pipe connected to the turbine and having a first end portion disposed in the pressure suppression pool; a cooling water supply pipe connected to the reactor pressure vessel and having a second end portion disposed in the pressure suppression pool; a pump coupled with the turbine and installed to the cooling water supply pipe; a steam condensing pool in which second cooling water is filled, disposed outside the primary containment vessel; a steam condenser disposed in the steam condensing pool; a second steam supply pipe connecting the reactor pressure vessel to the steam condenser; and a condensed water discharge pipe connected to the steam condenser for discharging condensed water generated in the steam condenser, and;
wherein another end portion of the condensed water discharge pipe is disposed in the pressure suppression pool.

7. The nuclear power plant according to claim 1,
wherein a valve is installed to the condensed water discharge pipe.

8. The nuclear power plant according to claim 2,
wherein a valve is installed to the condensed water discharge pipe.

9. The nuclear power plant according to claim 4,
wherein a valve is installed to the condensed water discharge pipe.

10. The nuclear power plant according to claim 5,
wherein a valve is installed to the condensed water discharge pipe.

11. The nuclear power plant according to claim 6,
wherein a valve is installed to the condensed water discharge pipe.

12. The nuclear power plant according to claim 2,
wherein a valve is installed to the first steam supply pipe.

13. The nuclear power plant according to claim 4,
wherein a valve is installed to the first steam supply pipe.

14. The nuclear power plant according to claim 5,
wherein a valve is installed to the first steam supply pipe.

15. The nuclear power plant according to claim 6,
wherein a valve is installed to the first steam supply pipe.

16. The nuclear power plant according to claim 1,
wherein at least one orifice is installed to either the steam supply pipe or the condensed water discharge pipe.

17. The nuclear power plant according to claim 1,
wherein at least one flow control valve is installed to either the steam supply pipe or the condensed water discharge pipe.
